(19) United States
(12) Patent Application Publication
(10) Pub. No.: US 2017/0308602 A1
(43) Pub. Date: Oct. 26, 2017

(54) Apparatus And Methods Of Data Synchronization

(71) Applicant: Landmark Graphics Corporation, Houston, TX (US)

(72) Inventors: Ramesh Kumar Raghunathan, Katy, TX (US); Ralph Lynn Nichols, Katy, TX (US); Keshava Prasad Rangarajan, Sugarland, TX (US); Chandra Yeleshwarapu, Houston, TX (US)

(21) Appl. No.: 15/529,780

(22) PCT Filed: Jan. 9, 2015
(86) PCT No.: PCT/US2015/010803

§ 371 Date: May 25, 2017

(51) Int. Cl. G06F 17/30; G06F 3/0484

(52) U.S. Cl. CPC G06F 17/30575; G06F 17/30578; G06F 17/30371; G06F 3/0484

(57) ABSTRACT

Various embodiments include apparatus and methods to synchronize virtualized data, or subsets of virtualized data, across a plurality of data repositories. The synchronization may be conducted in a data virtualization platform separate from the plurality of physical data repositories without requiring direct access to the plurality of physical data repositories. Additional apparatus, systems, and methods are disclosed.

### TECHNICAL FIELD

The present invention relates generally to apparatus and methods related to data synchronization.

### BACKGROUND

The term data virtualization describes an approach to data management that may include accessing data and manipulating data without knowledge of all the specifics of the data such as how it is formatted and where is physically located. Data virtualization approaches are currently directed to capabilities that attempt to abstract the technical aspects of stored data to provide a common logical data access point for connection to different data sources and to translate source data for a user entity among other things. These technical aspects may include location, storage structure, and storage technology among other physical features.

Data replication and synchronization methods and systems are prevalent for commercial and open-source database repositories. Considerable efforts have been made to deal with approaches to data synchronization. However, in typical current approaches, there are no direct methods that allow user entities to operate in a virtualized data environment without intervention with repositories directly. Many approaches, particularly those restricted to commercial database offerings, rely on employing change transaction replay based approaches to data synchronization where ordered source transactions are all applied in order to each of the destination systems. In large networks of repositories under active synchronization, such replay mechanisms needlessly duplicate superfluous change transactions with negative performance and latency consequences. Extant approaches also typically use specialized dialects, specific to each type of repository, and may not be adapted to work with semi-structured, unstructured, custom, and ad-hoc data repositories. Use of such repositories can be eased by exposing them via data virtualization platforms; however common data virtualization platforms offer little to no comprehensive data synchronization support.

### BRIEF DESCRIPTION OF THE DRAWINGS

FIG. 1 is a block diagram of an example system architecture, according to various embodiments.

FIGS. 2A-2K are block diagrams of example system interfaces that can be implemented in the system architecture of FIG. 1, according to various embodiments.

FIG. 3 is a block diagram of an example configuration model, according to various embodiments.

FIGS. 4A and 4B are flow diagrams of an example data synchronization flow, according to various embodiments.

FIG. 5 is a block diagram of features of an example core data model, according to various embodiments.

FIG. 6 is a flow diagram of an example method of synchronizing data, according to various embodiments.

FIG. 7 is a block diagram of an example system that can be implemented in the example system architecture of FIG. 1, in accordance with various embodiments.

### DETAILED DESCRIPTION

The following detailed description refers to the accompanying drawings that show, by way of illustration and not limitation, various embodiments that may be practiced. These embodiments are described in sufficient detail to enable those skilled in the art to practice these and other embodiments. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

In data management of different systems, an important feature can include synchronization of data across these different systems. In other words, as data changes in one system, the same changes or the state of one system should be echoed verbatim in another system. Given a data repository that contains some entities and some attributes for those entities, a task is to synchronize that state with another repository. Such synchronization can include data conflicts between different entities.

A problem for conflict detection that is largely unsolved in many existing approaches involves conflict detection across an object instance hierarchy or graph, where the entire collection is collectively synchronized, when a conflict is detected at any level in that collection. Such detection may be extremely difficult to accomplish with current methods that treat each object instance atomically for synchronization and impose an ordering prior to synchronization only to manage repository constraints such as, but not limited to, foreign keys. In addition, most approaches typically offer limited support for complex data subset specification(s) that constrain the subset set of objects (and the subset of their attributes) that are to be synchronized from a source to a destination. In particular, in a data virtualization environment, the specification of a data subset can span multiple repositories and involve very complex queries that may be hard to accomplish with current methods. Another complexity arises when these subset queries also dynamically vary over time based on information in multiple repositories. In various embodiments, a data virtualization layer can be structured to be directed to addressing the abovementioned issues.

In various embodiments, a data virtualization platform can be structured as a data virtualization layer such that access to repository objects can be attained where direct connectivity to the repository objects is not possible. The data virtualization platform can be implemented to operate on objects that are exposed via views that may transform the original repository content significantly. The data virtualization platform can be implemented to operate on objects, where object definitions may be different between source and destination repositories. The data virtualization platform can be implemented to operate on objects that may be composed of attributes simultaneously derived from multiple heterogeneous repositories, for instance a relational database, a spreadsheet, and an XML (extensible markup language) web service. The data virtualization platform can be structured as abovementioned without intervention with repositories directly for execution of procedures, such as stored procedures and triggers. The data virtualization platform can be structured, unlike typical extant methods and systems, to operate without assuming that the source and destination entities in a synchronization procedure and attribute definitions are identical or that each object is synchronized in its entirety with all associated attributes. In addition, the data virtualization platform can be structured, unlike typical extant methods and systems, to operate without exchange synchronization meta-data between synchronizing repositories, which can eliminates designing data repositories to store such meta-data.

In various embodiments, a method, a configuration mechanism, and an execution framework is provided such that any of these repositories can be synched, where operation is in a virtualized data environment. Embodiments of a data virtualization layer, which abstracts away the connection detail and the other assorted details regarding communication of a user instrument directly to a data repository, can be structured to operate in a data virtual arena that includes syncing multiple repositories. For example, a SQL (structured query language) server database, an Oracle database, an Excel file, a web service, or other electronic containing data can be situated in the data virtual environment, and can be treated identically. Further, a data virtualization platform can be structured such that any metadata information about that a synchronization—process, mechanism—does not need to be stored in either of the two repositories synced, or transferred from one repository of the synchronization to another repository of the synchronization. Such a data virtualization platform need not physically alter any of those repositories that are being synchronized.

In various embodiments, data synchronization may result in no additional data to the repositories beyond the entities that need to be synchronized. Two aspects of such an approach can include not changing a data repository, and secondly, not moving anything from one repository to another repository other than data of the entities being synchronized. The entities and the attributes of the entities being synchronized do not need to be identical. Synchronization may include syncing portions of data. For example, data in one repository being structured with three decimal places can be synced with the data in another repository being structured with five decimal places to the extent of data having three decimal places.

A data virtualization layer, realized by a data virtualization platform, does not store anything in a persistent manner; it eventually pushes the synced data down to the data repository of interest in the synchronization. In an embodiment, during a synchronization procedure, at the time that data is synchronized, only the latest state of one repository is synchronized to another repository, such that redundant or unnecessary change transactions are not inefficiently replayed.

In a synchronization process, changes are made to a destination repository to sync with data in a source repository, at least to an extent corresponding to attributes of an entity in the destination repository. The terms source and destination are in reference to a initiating a synchronization, where in a procedure one repository is a source and another repository is a destination and, in another procedure, the roles of the two repositories are reversed with respect to source and destination. Before any changes are applied, a determination can be made as to whether a change is warranted or not. The detection process can include a comparison. The comparison may be conducted recursively. The detection mechanism can conduct a three-way match. It compares the value of the source repository, the value in the destination repository, and prior value that was either synced or moved from one repository to the other. Based on this three way comparison, you can figure out all the different combinations can be determined, and thereby determine how to synchronize. The detection mechanism can overlaps these three determinations, recursively, to figure out what actually needs to change on the target. In a case where there has been a change, a configuration can be looked up in the data virtualization platform to determine whether these changes should override the data or should these changes just be ignored. With respect to ignoring, no action is taken. If changes are to be applied, the comparison mechanism is executed with respect to the data coming in, including the non-changed parts, the data existing, and prior value. The comparison again can be conducted recursively.

Changes can also be made with respect to a hierarchy. The source and destination entities are being treated atomically. In other words, a change anywhere in the hierarchy can be treated as an atomic change across the entire hierarchy. The entire hierarchy is synchronized, rather than a single entity, and a single attribute.

In various embodiments, synchronization in a data virtualization layer can take into account hierarchical relationships between entities. Such relationships may be used to further improve conflict detection of data from a plurality of sources. Hierarchical clustering can be used in a virtualized database environment to synchronize composite data-types in which changes to two or more entities which share a single root ancestor, by convention, may be applied from one source or another, but may not both be applied.

An embodiment of hierarchical clustering may start with an introduction of a hierarchical configuration, stored in a file or database, which indicates that related types are hierarchical and the relations that bind the hierarchy. For example, a configuration may indicate that entity type D is a child of entity type A by a specific foreign key, and that C is a child to entity type B by a specific foreign key, which in turn is a child to entity type A by a specific foreign key. Thus, the types A, B, C, and D are said to form a hierarchy, the hierarchy [C=>B=>A, D=>A]. Next, a term “hierarchical cluster” or “cluster” can be introduced. A hierarchy indicates the types of a hierarchy, while a cluster are the particular entities of a hierarchy. The entities of a cluster are related relationally by foreign keys that bind the hierarchy; that is, their foreign keys described in the configuration match relational keys of the related parent and the types of entities of the hierarchy. For example, consider the case where entity ‘a’ of type A is related to entity ‘d’ of type D by the specific foreign key described in the configuration, and no other entity is related to ‘d’ by this specific foreign key. Therefore, [‘a’, ‘d’] forms a complete cluster by the hierarchy [C=>B=>A, D=>A].

Embodiments of clustering hierarchically can be described using the abovementioned terminology. Some embodiments may be conducted by transforming a change log, once upon extraction from its source, and again upon application to a target. Upon extracting the change log, the order of the log can be remembered by assigning an integer value to each entity, representing the order in which they were encountered in the change log. Next, the hierarchical entities found in the log can be put into their respective clusters by comparing entities against their prospective parent entities to determine if the foreign key matches as described in the configuration. The cluster is then compared against contents of the source database by performing queries using the foreign keys of the configuration against the each of the entities of the cluster. If any entities are found to be related to the cluster entities, they are added to the cluster as a change log entry in which no entity attributes changed, and assigned the next available integer value of the log ordering. The comparison can continue against the newly added entities until no more entities can be found. Once the comparison procedure is complete, the entire set of entities, those that are now within the clusters, and the entities which were not relational, can be put back into an array and sorted by their assigned order value, thus completing the extraction transformation.

A final portion of the hierarchical transform may occur during log application time. Upon attempted application of a change log, the change log can again be assigned integer values denoting their order and hierarchical clusters are grouped together, as described in the source extraction step. A global change queue can be created and readied for new entries. Non-hierarchical entities can be added to the global change queue. At this point, each source cluster can be compared against a target cluster containing the contents of the target virtual database. The target cluster can be built by taking a copy of the cluster root and performing the cluster building steps described in the source extraction. The comparison of target and source clusters can be accomplished by overlaying the tree structures with the clusters formed by comparing the primary keys of the entities, and then adding changes to a local queue. Where the entities are found to match by primary key, the entities can be compared by their remaining attributes, and if found to be different, an update change log entity can be added to the change queue and assigned the order value of the source entity, and the cluster can be noted to be in conflict. Where entities are found to exist in the source cluster, but not the target cluster, an insert change log entity can be added to the change queue assigned with the next order integer value, and the cluster can be noted to be in conflict. Where entities are found to exist in the target cluster, but not the source cluster, a delete change log entity can be added to the change queue assigned with the next order integer value, and the cluster can be noted to be in conflict. A conflict policy can then be consulted. If the conflict policy indicates that incoming conflicts should not be applied, the local queue can be discarded. If the conflict policy indicates that the incoming conflict should be applied anyway, the contents of the local queue can be added to the global change queue.

At this point, the changes can be collected. As part of a final procedural, the global change queue can be sorted according to the assigned ordering value. With the hierarchical transformation complete, the contents of the global change queue can be passed onto the remainder of the synchronization process as the change log to be applied.

In various embodiments, source and destination repositories can be related functionally, which can be called ID (identification) matching. In a relational structure, a primary key can be used in such ID matching. Consider two user instruments importing data relative to the same object, using the same name. In one repository, the object is associated with a primary key having a value of N and, in the other repository, the object is associated with a primary key having a value of M. In the data virtualization platform, the primary key can be structured as ID integer—a single number that is uniquely assigned when each row is created in the repository. When the change that comes across to the object with primary value N, the change request is sent out with the name of the object that is held in a configuration file. The name is a natural key. Before the change is applied in the other repository, the incoming change is examined and it is determined that the incoming change is associated with the name of the object in the repository, which has a primary value of M. The change set that is applied can be based on a conflict policy, which may be set relative to the primary key. In various embodiments, a primary key may include several parts especially with increased nesting in the relational structure.

In various embodiments, changes at the column level in virtual data in a virtual environment are tracked. Therefore, a given repository can synchronize one set of its attributes to a second repository, and can synchronize a completely different set concurrently to a third repository. This approach may provide complete flexibility, in terms of the fractions of the data they can be moved around different repositories.

Key mapping can be conducted in the presence of additional unique constraints. While synchronizing database changes in a virtual database environment, in which entities have primary keys and additional unique constraints, where the unique constraint determines the entity identity in preference over the primary key, one can encounter a particular type of conflict in which two of the same entities, considered to be the same by comparing the additional unique constraint, may have been added on both sides of the virtual database environment, such that one cannot add one entity from one source side to a target side without violating the unique constraint, thus producing the so called create-create conflict.

Embodiments, as taught herein, can be used to resolve these conflicts automatically by attaching uniqueness information to the record of the entity change log in the queue after, where pending changes to a target can be re-written before applying them by changing the primary key in the pre-application change log to match the existing key on the target side.

The method of re-writing the change log can start by attaching uniqueness information to a change log when the entity's change log is recorded on the source side. Upon recording the change, the primary key can be recorded in the change log. The method can add the uniqueness information by recording the tuple of values, one for of each of the columns of the unique constraint. In addition, if any of the columns of the unique constraint are foreign keys to other entities and the related key in the related entity is found to be the primary key of the related entity and the related entity has a unique constraint of its own, then the tuple of values from the related entity can be substituted for the entry of the foreign key. The method of substituting tuples for foreign keys can continue on the substituted tuples until no more substitutions can be made.

The re-writing method may finish when it updates the primary keys in the change log before attempting to apply the change to the target side. The re-write can be accomplished by retrieving the uniqueness constraint from the entity's change log, then attempting to extract the equivalent primary key on the target side that matches the uniqueness information. The entity on the target side that matches the uniqueness tuple can be obtained by virtual database query; the values of the target entities unique constraint columns need to match the equivalent column in the uniqueness tuple. If the equivalent column is found to be a tuple itself instead of a single value, it is because that column is a foreign key, in that case the primary key of the foreign entity, where the columns of the unique constraint on that foreign entity that matches the tuple is substituted for the tuple in the uniqueness tuple by the same method. Since the tuples contain tuples, the method can recursively evaluate tuples into primary keys, until finally the primary key that matches the entire uniqueness tuple is obtained. Upon obtaining the final primary key, the primary key can be substituted for the primary key in the change log. The re-writing is complete at this point, because the primary key and unique constraint columns match in the change log, the conflict due to having primary keys with an additional unique constraints has been resolved.

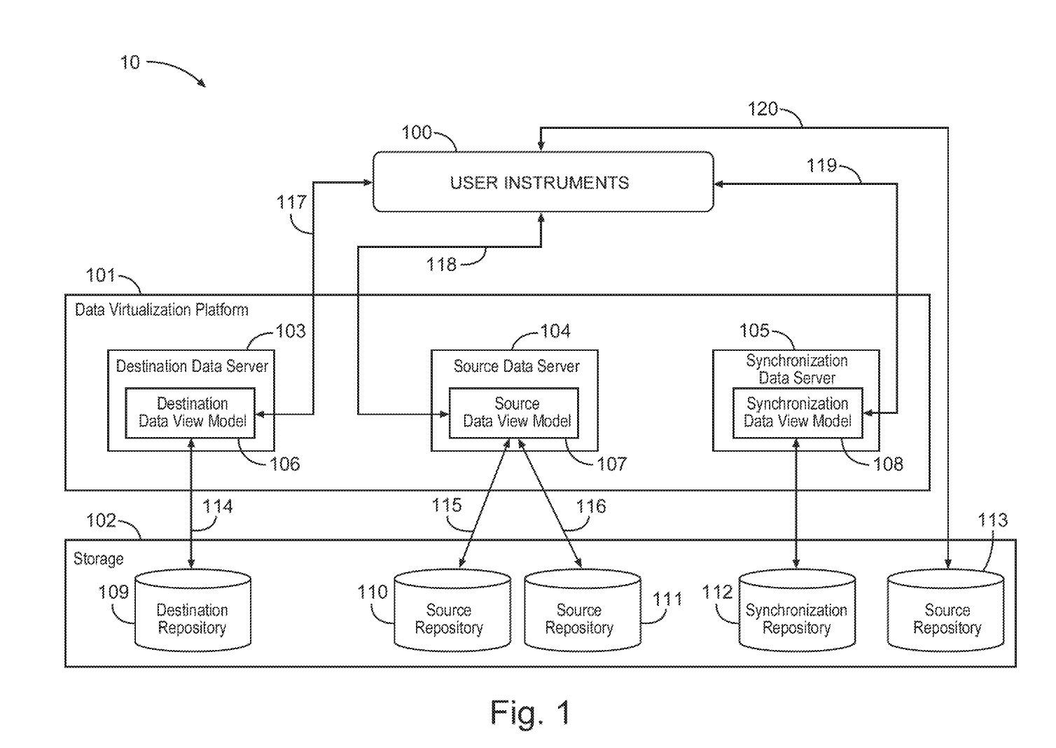

FIG. 1 is a block diagram of an embodiment of an example system architecture 10. The system architecture 10 can include a data virtualization platform 101 managing data flow from user instruments 100 to storage 102 such the user instruments 100 do not directly connect to storage 102 or components of storage 102, directly go through the data virtualization platform 101. The user instruments 100 may not have any information regarding the location of or routing to storage 102 or components of storage 102. The user instruments 100 may include, but are not limited to, mobile devices, applications, instrumentality of services, and systems. The user instruments 100 essentially “see” the presentation of the source, or a view of the source, of storage 102 and underneath user instruments 100, the data virtualization platform 101 handles the translation between that view and the actual physical data that is stored in storage 102.

The data virtualization platform 101 can include a destination data server 103, a source data server 104, and a synchronization data server 105. The destination data server 103 can include a destination data view model 103-1. The source data server 104 can include a source data view model 104-1. The synchronization data server 105 can include a synchronization data view model 104-1.

The storage 102 can include a destination repository 109, a source repository 110, a source repository 111, a synchronization repository 112, and a source repository 113. These repositories can be realized as separate physical components, where each component may be remote from various ones of the separate physical components. The destination repository 109 can be coupled to the destination data server 103 by communication path 114 to provide bidirectional communication of data to the destination data view model 103-1. The source repository 110 and the source repository 111 can be coupled to the source data server 104 by communication paths 115 and 116, respectively, to provide bidirectional communication of data to the source data view model 104-1.

The synchronization repository 112 can be coupled to the synchronization data server 105 by communication path 114 to provide bidirectional communication of data to the synchronization data view model 105-1. The synchronization repository 112 can store all of that metadata and states related to what has already been synchronized between two repositories and store what remains to be done.

The source repository 113 can be coupled to the user instruments 100 by communication path 121 to provide bidirectional communication of data to the user instruments 100. The source repository 113 may be structured as a local database of the user instruments 100.

The data virtualization platform 101 may be structured to synchronize all virtualized data, or subsets of such data, as needed, across heterogeneous data repositories, regardless of the data source or origin, such as commercial databases, files, data inside spreadsheets, web services, mobile devices, big data repositories, cloud repositories, No-SQL repositories, or any other type of virtualized data repository, without requiring any direct access to those repositories during the synchronization. The data virtualization platform 101 may be structured to operate to perform one or more of the following tasks: read configuration information regarding sources, destinations, and data mappings; update a subset of originating data destined for a receiver destination; check the source for new changes since the last such check; identify the pending changes for the destination since the last such synchronization; check for any conflicts for pending changes; apply an appropriate conflict resolution policy; order entities in a selected right execution order prior to synchronizing data; apply pending insertions first; apply updates following application of the pending insertions first; apply deletes following application of updates following application of the pending insertions first; track and log any errors encountered during these operations; and record a transaction summary of the complete synchronization process.

The data virtualization platform 101 or a data virtualization platform similar to data virtualization platform 101 may be structured to periodically invoke procedures to enable various data repositories to incrementally achieve identical data content across any connected network of repositories in any deployment configuration. Such deployment configuration may include, but is not limited to, peer to peer, hub to spoke, master to slave, among any others. The data virtualization platform 101 or a data virtualization platform similar to data virtualization platform 101 may include a scheduler, a timer, an executable task, and procedures using these components.

The data virtualization platform 101 or a data virtualization platform similar to data virtualization platform 101 may be structured to configure the data virtualization platform 101 or a data virtualization platform similar to data virtualization platform 101 to specify data mapping between the source and destination repositories. The data virtualization platform 101 or a data virtualization platform similar to data virtualization platform 101 may include one or more of the following: a configuration schema definition that constrains the validity of configuration information; connection information for the virtualized sources and destinations required by the data virtualization platform 101 or a data virtualization platform similar to data virtualization platform 101; parameters, such as synchronization interval or frequency, that govern the execution of the data virtualization platform 101 or a data virtualization platform similar to data virtualization platform 101; and a mapping between the source and destination entities and their attributes to implement methods of synchronization of the data virtualization platform 101 or a data virtualization platform similar to data virtualization platform 101.

A data model and/or schema to store data and meta-data may be associated with the data virtualization platform 101 or a data virtualization platform similar to data virtualization platform 101 and methods of operating the data virtualization platform 101 or associated with operating a data virtualization platform similar to data virtualization platform 101 as taught herein. The model can include entities and relationships that track one or more of the following: the meta-data, including an incrementing change tracking counter, associated with changed attributes of all entities of all repositories as configured by the data virtualization platform 101 or a data virtualization platform similar to data virtualization platform 101; the meta-data associated with a subset of data from one originating repository to a destination repository as configured by the data virtualization platform 101 or a data virtualization platform similar to data virtualization platform 101; the meta-data associated with the information gathered during prior synchronization cycles between the source and destination repositories; and any error associated with propagating the actual change associated with any given change meta-data. A data model and/or schema may be structured to store synchronization transaction information. The synchronization transaction information may include date and time of the conclusion of the synchronization activity, the unique source identifier, the unique destination identifier, the source entities, the destination entities, the source attributes, the destination attributes, the count of synchronized entities, the count of synchronized attributes, the count of entities with errors during synchronization, the count of attributes with errors during synchronization, and the starting and ending values of the meta-data counter.

The data virtualization platform 101 or a data virtualization platform similar to data virtualization platform 101 may be structured to check for any conflicts for pending changes. The data virtualization platform 101 or a data virtualization platform similar to data virtualization platform 101 may be structured to perform one or more of the following: conduct a three way match to detect attribute change conflicts by comparing a hash, or unique numeric code, of the source content, the hash, or unique numeric code, of the destination content, and the stored hash, or unique numeric code, of the last known synchronized content; take into account the hierarchical relationships between entities to further improve conflict detection; and c) skip the pending change if it is detected that the destination already has the same content as source change.

The data virtualization platform 101 or a data virtualization platform similar to data virtualization platform 101 may be structured to apply an appropriate conflict resolution policy that resolves detected conflicts outlined above with respect to check for any conflicts for pending changes, conduct a three way match, taking into account hierarchical relationships, and skip a pending change. The data virtualization platform 101 or a data virtualization platform similar to data virtualization platform 101 may be structured to apply an appropriate conflict resolution policy by conducting an operation including determination of the winner in the event of a conflict as specified by the configuration discussed above to specify data mapping between the source and destination repositories. The configuration may include one or more of the following: a configuration schema definition that constrains the validity of configuration information; connection information for the virtualized sources and destinations required by the data virtualization platform 101 or a data virtualization platform similar to data virtualization platform 101; parameters, such as synchronization interval or frequency, that govern the execution of the data virtualization platform 101 or a data virtualization platform similar to data virtualization platform 101; and a mapping between the source and destination entities and their attributes to implement methods of synchronization of the data virtualization platform 101 or a data virtualization platform similar to data virtualization platform 101. The data virtualization platform 101 or a data virtualization platform similar to data virtualization platform 101 may be structured to apply an appropriate conflict resolution policy that resolves detected conflicts including cancelling or applying the pending change as inferred from the determined policy.

The data virtualization platform 101 or a data virtualization platform similar to data virtualization platform 101 may be structured to operate in conjunction with the stored change meta-data as discussed above with respect to a data model and/or schema to store data and meta-data. Such a combination can be provided to ensure one or more of the following: change meta-data is tracked at the entity and attribute level thereby allowing partial entity synchronization in the event that a destination is only interested in a subset of the attributes and entities; the meta-data change counter enables the incremental synchronization of only the latest changes from a source repository to multiple concurrent destinations each of whom may require disparate subsets of source data; deleted information is correctly propagated even when the source repositories do not retain, or provide, information regarding deleted information; redundant and spurious cycles of change related updates are prevented from repositories that synchronize symmetrically; remain robust and error free in the event that entities and attributes are removed or augmented from the schema of the source and destination repositories; eliminate the need to synchronize system or server clocks across the synchronizing networks of repositories; obviate the need to store intermediate copies of actual change data in any repository; and allow any query specification dynamically at runtime to control the subset of data synchronized between a source and a destination.

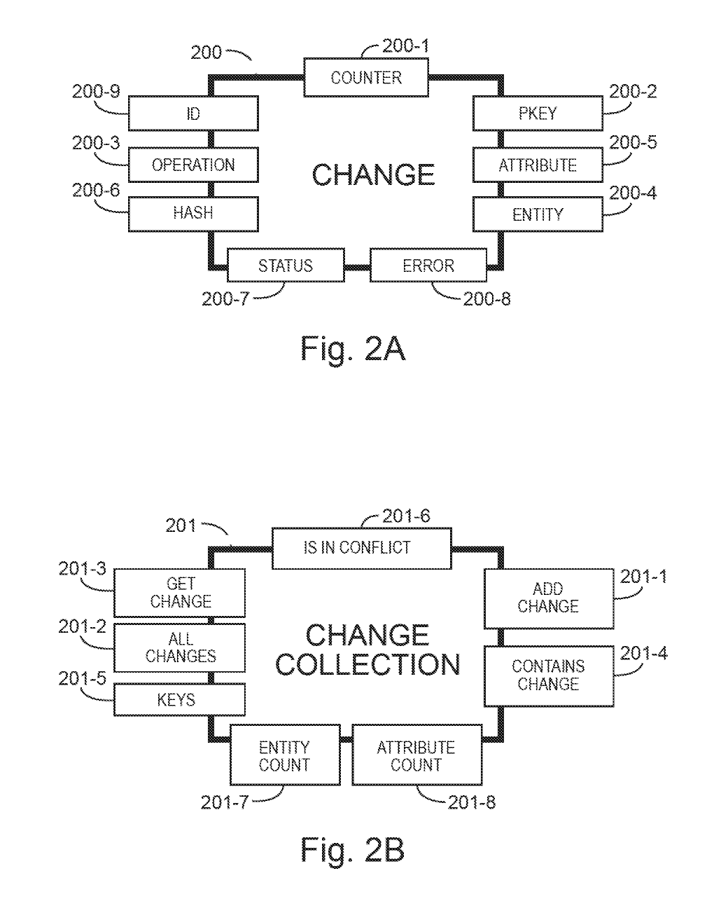

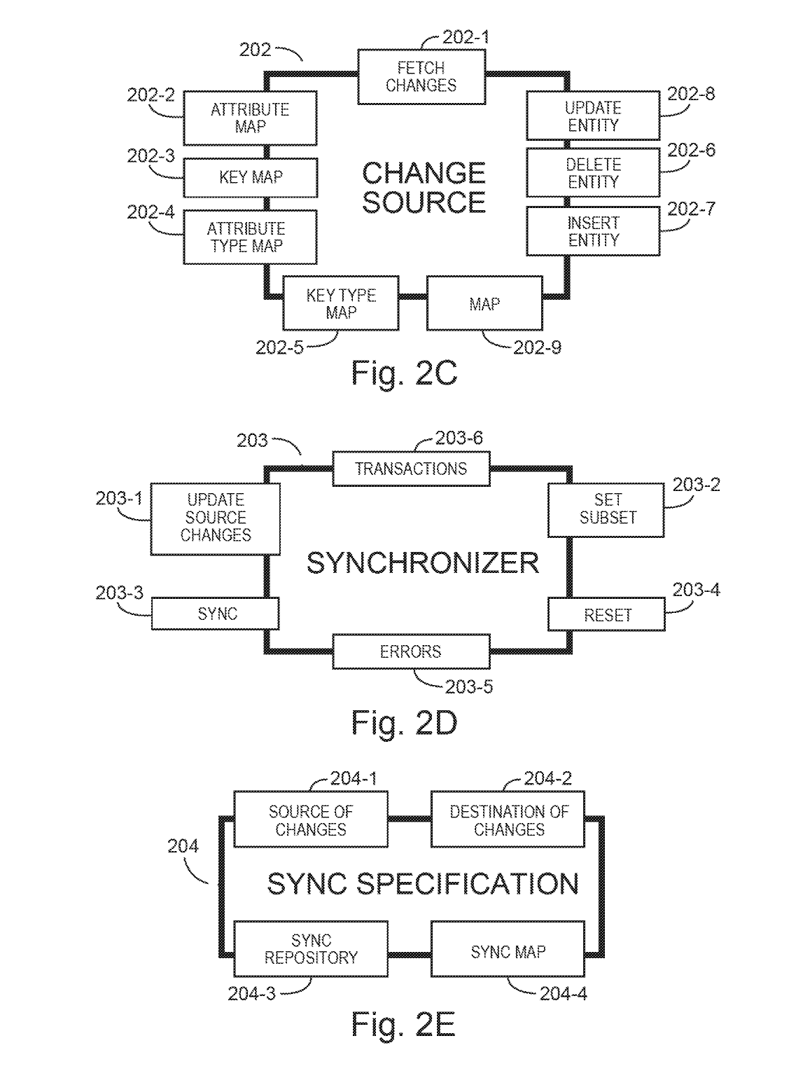

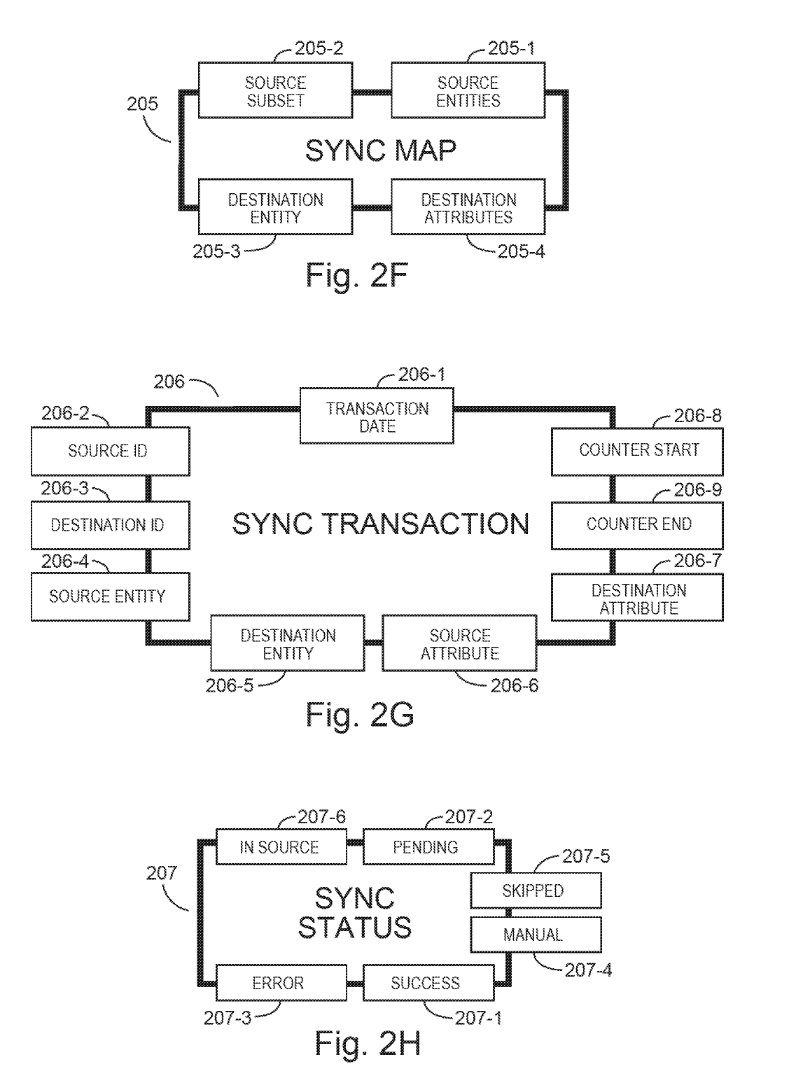

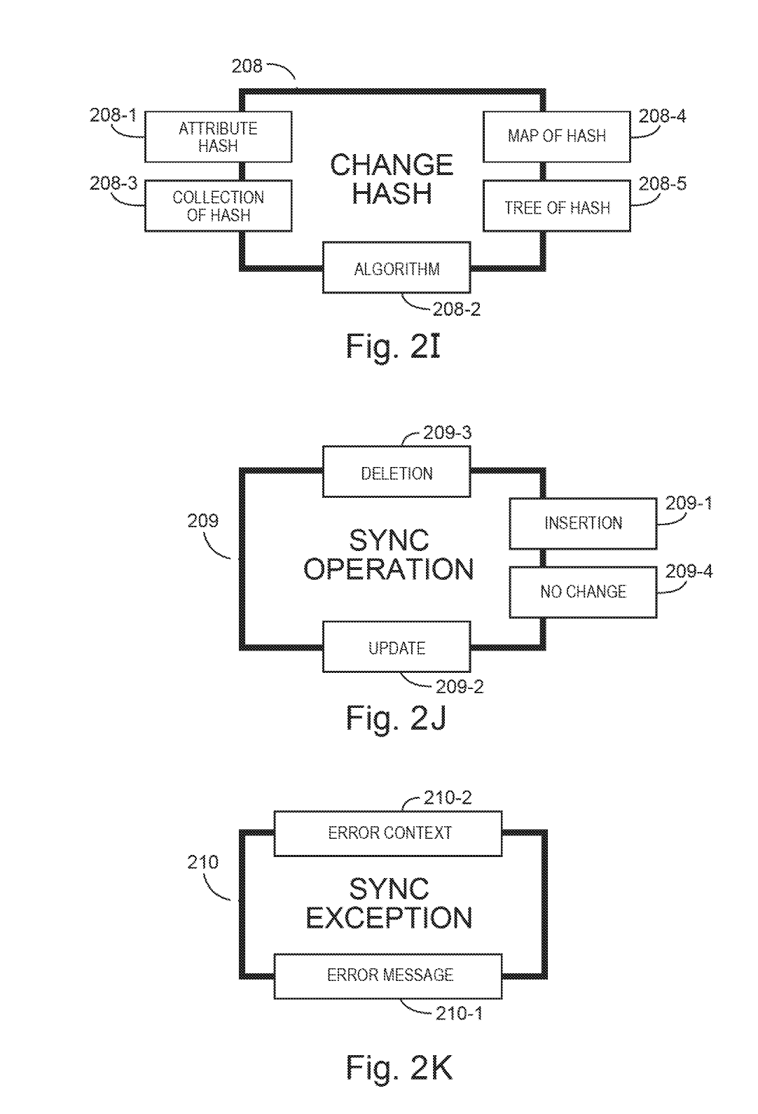

FIGS. 2A-2K are block diagrams of embodiments of example system interfaces that can be implemented in the system architecture 10 of FIG. 1. An interface can be realized by a module that can provide executable procedures. These interfaces may provide for realization of methods and systems as taught herein. FIGS. 2A-2K are block diagrams of embodiments of example system interfaces that can be implemented in the system architecture 10 of FIG. 1. These interfaces may provide for realization of methods and systems as taught herein. FIG. 2A is a block diagram of an embodiment of an example change interface 200. The change interface 200 can have a change counter 200-1 and can be arranged to hold a unique repository identifier 200-2 that can be structures as a primary key, a change operation 200-3, an entity name 200-4, an ID 200-9, an attribute name 200-5, a hash of the changed attribute value 200-6, a change status 200-7, and an optional error 200-8. The change operation can be an insert, an update, or a delete.

The change counter can be structured to maintain change version to keep track of version stored in metadata. It can keep track of every detail. This change counter can be stored in a synchronization metadata repository, which can be arranged to store metadata but does not store any of the actual values of any of the entities that are being synchronized. The change counter allows tracking across multiple synchronizations. In addition, a hash of the actual value, where the hash is a signature of what the value is, can be maintained. A signature of a data entry can be calculated on the hash, which allows for comparison of the hash values to determine if there has been a change. For example one may have a large file that can be compressed to a number, or a specific number, such that if the number is different than a previously stored hash, the comparison indicates that the entity has changed in some manner. The whole file need not be fetched to determine whether there has been any change in it. A comparison of its hash indicates that there has been a change, which allows for keeping keep track of the version.

FIG. 2B is a block diagram of an embodiment of an example change collection interface 201. The change collection interface 201 can comprise instrumentality to add a change 201-1, iterate through collected changes 201-2, retrieve a specific change 201-3, check if the collection contains a specific change 201-4, manage a list of entity keys for the change collection 201-5, check if a given change is in conflict with that collection of changes 201-6, and keep an entity count 201-7 and an attribute count 201-8.

FIG. 2C is a block diagram of an embodiment of an example change source interface 202. The can change source interface 202 can include instrumentality to fetch the latest changes 202-1, the attributes of each entity exposed by the source for synchronization 202-2, the list of the attribute data types for the entity attributes 202-3, the key attributes for every entity 202-4, the types of the key attributes for every entity 202-5. The change source interface 202 can be structured to delete an entity 202-6, insert an entity 202-7, update an entity 202-8, and specify a mapping 202-9 to a configured destination entity as taught herein

FIG. 2D is a block diagram of an embodiment of an example synchronizer interface 203. The synchronizer interface 203 can include instrumentality to retrieve new source changes 203-1, set subsets of data from a source to a destination 201-2, synchronize two repositories 203-3, reset change tracking meta-data 203-4, provide the errors encountered 203-5, and log and report on the transactions 203-6. The synchronizing of the two repositories may include a permutation of one or more of the following operations: reading configuration information regarding sources, destinations, and data mappings; updating the subset of originating data destined for the receiver repository; checking the source for new changes since the last such check; identifying the pending changes for the destination since the last such synchronization; checking for any conflicts for pending changes; applying an appropriate conflict resolution policy; ordering the entities in the right execution order prior to synchronizing data; applying pending insertions first followed by applying updates and then deletes; tracking and logging any errors encountered during these operations; and recording a transaction summary of the complete synchronization process.

FIG. 2E is a block diagram of an embodiment of an example sync specification interface 204. The sync specification interface 204 can include a source repository 204-1, a destination repository 204-2, a repository to store the synchronization meta-data 204-3, and a mapping between source entities and destination entities 204-4.

FIG. 2F is a block diagram of an embodiment of an example sync map interface 205. The sync map interface 205 can include a list of a source entity 205-1, a query which when executed on the source repository specifies the data subset 205-2 targeted for the destination repository 205-3, and a set of attribute mappings from the source entity to the destination entity 205-4.

FIG. 2G is a block diagram of an embodiment of an example sync transaction interface 206. The sync transaction interface 206 can provide the attributes store synchronization transaction information including date and time of conclusion of the synchronization activity 206-1, a unique source identifier 206-2, a unique destination identifier 206-3, source entities 206-4, destination entities 206-5, source attributes 206-6, destination attributes 207-7, and the starting 206-8 and ending 206-9 values of a meta-data counter.

FIG. 2H is a block diagram of an embodiment of an example sync status interface 207. The sync status interface 207 can provide the status of an ongoing synchronization operation via states that cycle between labels of success 207-1, pending 207-2, error 207-3, manual 207-4, skipped 207-5, and in source 207-5.

FIG. 2I is a block diagram of an embodiment of an example change hash interface 208. The change hash interface 208 can include instrumentality to provide a hash or unique numeric code or any attribute value 208-1. The change hash interface 208 can include an algorithm employed to compute this hash value 208-2, and various data structures to maintain groups of such hashes such as collections 208-3, maps 208-4, and trees 208-4.

FIG. 2J is a block diagram of an embodiment of an example sync operation interface 209. The sync operation interface 209 can describe modes and manner of changes such as insertions 209-1, updates 209-2, deletions 209-3, and no change 209-4.

FIG. 2K is a block diagram of an embodiment of an example sync exception interface 210. The sync exception interface 210 can provide a synchronization error message 210-1 and any context associated with that error message 210-2.

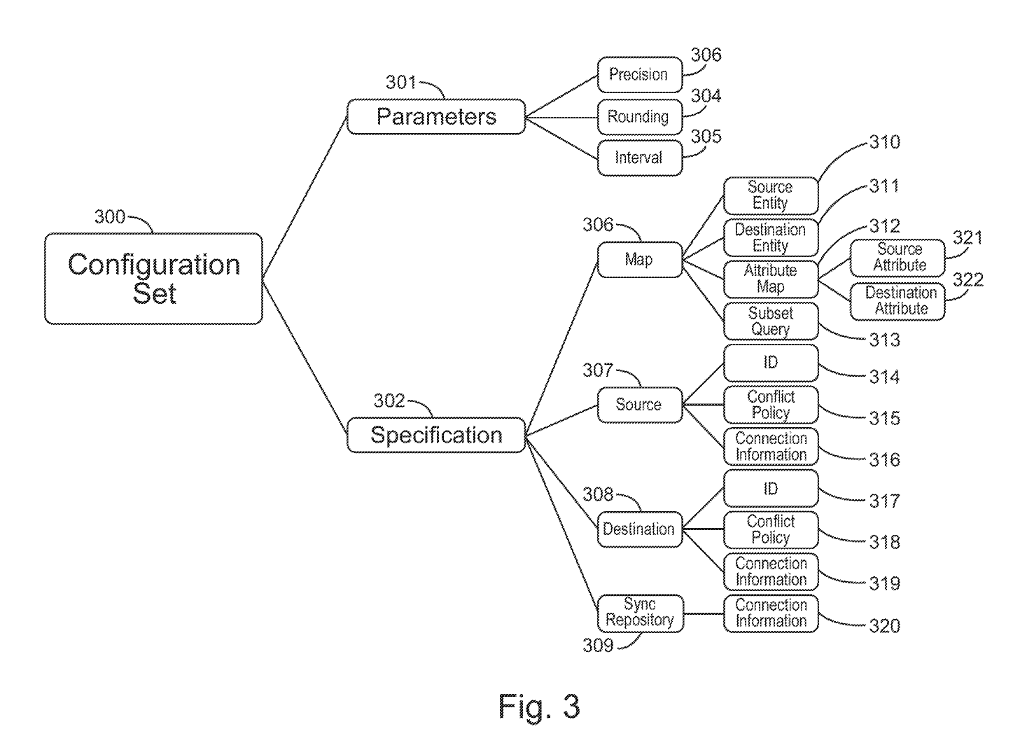

FIG. 3 is a block diagram of an embodiment of an example configuration model for a configuration set 300. The configuration set 300 can include parameters 301 and specification 302. The parameters 301 can include, but are not limited to, precision parameter 303, rounding parameter 304, and interval parameter 305. The interval parameter 305 can specify how often a synchronization is to be performed. The specification 302 includes configuration data of a map 306, a source 307, a destination 308, and a sync repository 309. The sync repository 309 can include connection information 320.

The map 306 can include configuration data of a source entity 310, a destination entity 311, an attribute map 312, and a subset query 313. The attribute map 312 can include configuration data for a source attribute 321 and a destination attribute 322.

The configuration data for the source 307 can include an ID 314, a conflict policy 315, and connection information 316. The conflict policy 315 can be realized in a number of ways. The conflict policy 315 can be the identity of a conflict winner. The conflict policy 315 can be a set of rules by which to determine which entity is the conflict winner.

The configuration data for the destination 308 can include an ID 317, a conflict policy 318, and connection information 319. The conflict policy 318 can be realized in a number of ways. The conflict policy 318 can be the identity of a conflict winner. The conflict policy 318 can be a set of rules by which to determine the entity that is the conflict winner.

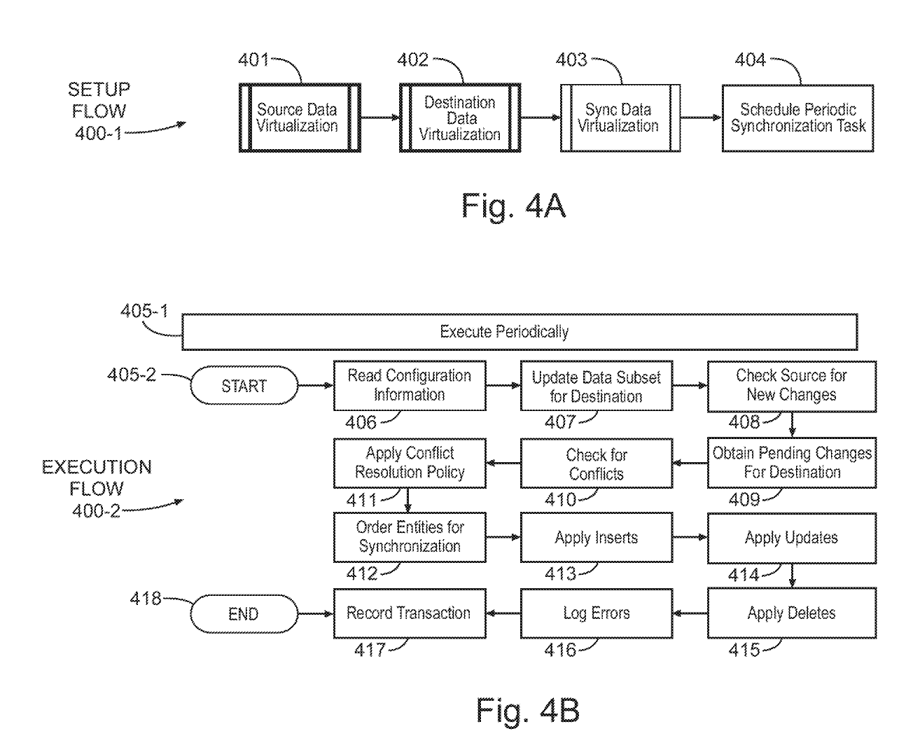

FIGS. 4A and 4B are flow diagrams of an embodiment of an example data synchronization flow. FIGS. 4A shows a setup flow 400-1 to prepare for a synchronization procedure. At 401, source data virtualization is conducted. At 402, destination data virtualization is conducted. At 403, sync data virtualization in conducted. At 404, a periodic synchronization task is scheduled. Prior to synchronization, configuration data is enabled in the data virtualization layer such that synchronization in the data virtualization layer, via a data virtualization platform such as data virtualization platform 101 of FIG. 1, can be conducted separate from a plurality of physical data repositories without requiring direct access to the plurality of data repositories during synchronization. Referring to FIG. 1 as an example, during the setup flow 400, data can be communicated from the destination repository 109 to the destination data view model 103-1, data can be communicated from the source repositories 110 and 111 to the source data view model 104-1, and from synchronization repository 112 to the synchronization data view model 105-1.

FIGS. 4A shows an execution a flow 400-2 to perform a synchronization procedure. At 405-1, an indication can be provided to execute the synchronization procedure at a specified period. Other triggers may be to initiate the synchronization procedure. The execution of the synchronization procedure can start 405-2 in response to the specified period occurring or the trigger being detected. At 406, configuration information is read. The read configuration information can include which sources, which destinations, all the mappings between which entities can sync with which entities, the timing interval, everything to be used to manage synchronization at the data virtualization layer. At 407, data subset for destination is updated. At 408, the source is checked for new changes. At 409, pending changes for the destination are obtained. At 410, a check for conflicts is conducted. At 411, conflict resolution policy is applied. At 412, entities for synchronization are ordered. At 413, inserts are applied. At 414, updates are applied. At 415, deletes are applied. At 416, errors are logged. At 417, the transaction of the synchronization is recorded. At 418, the synchronization process is ended. The execution flow can proceed for every pair of entities and every combination.

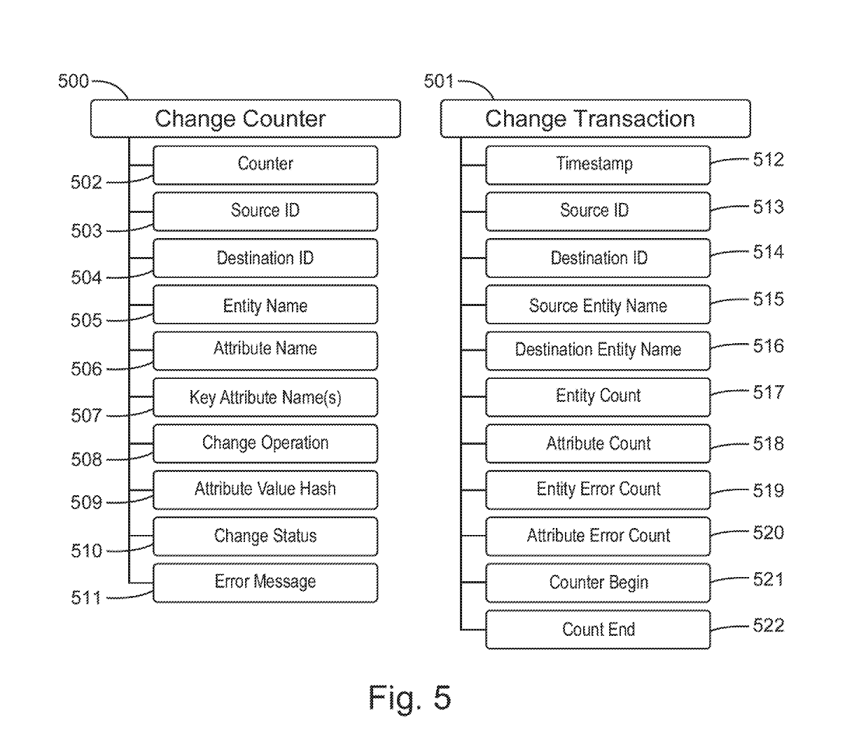

FIG. 5 is a block diagram of features of an embodiment of an example core data model. The core data model can include a change counter 500 and a change transaction 501. Change counter 500 can comprise a counter 502, a source ID 503, a designation ID 504, an entity name 505, an attribute name 506, key attribute name(s) 507, change operation 508, attribute value hash 509, and error message 511. The change counter 500 allows the data virtualization layer to keep track of every detail, every column, every entity, and every pair of repositories without a time limit. It is one of the items that can be stored in the metadata for the synchronization. In various embodiments, none of the actual values of any of the entities that are being synchronized is stored in the synchronization metadata repository. The only information stored, in these embodiments, is metadata, which includes the change counter 500 that is the most common type of metadata stored.

Change transaction 501 can be structured to provide an accounting of a synchronization procedure. The change transaction can include a timestamp 512, a source ID 513, a destination ID 514, a source entity name 515, destination entity name 516, an entity count 517, an attribute count 518, an entity error count 519, an attribute error count 520, a counter begin 521, and a count end 522. The change transaction 501 provides a record, for example, noting the time that a given repository is synchronized with another identified repository number, the total entities synced, the total attributes synced, all of the errors found, a starting time, an ending time, etc.

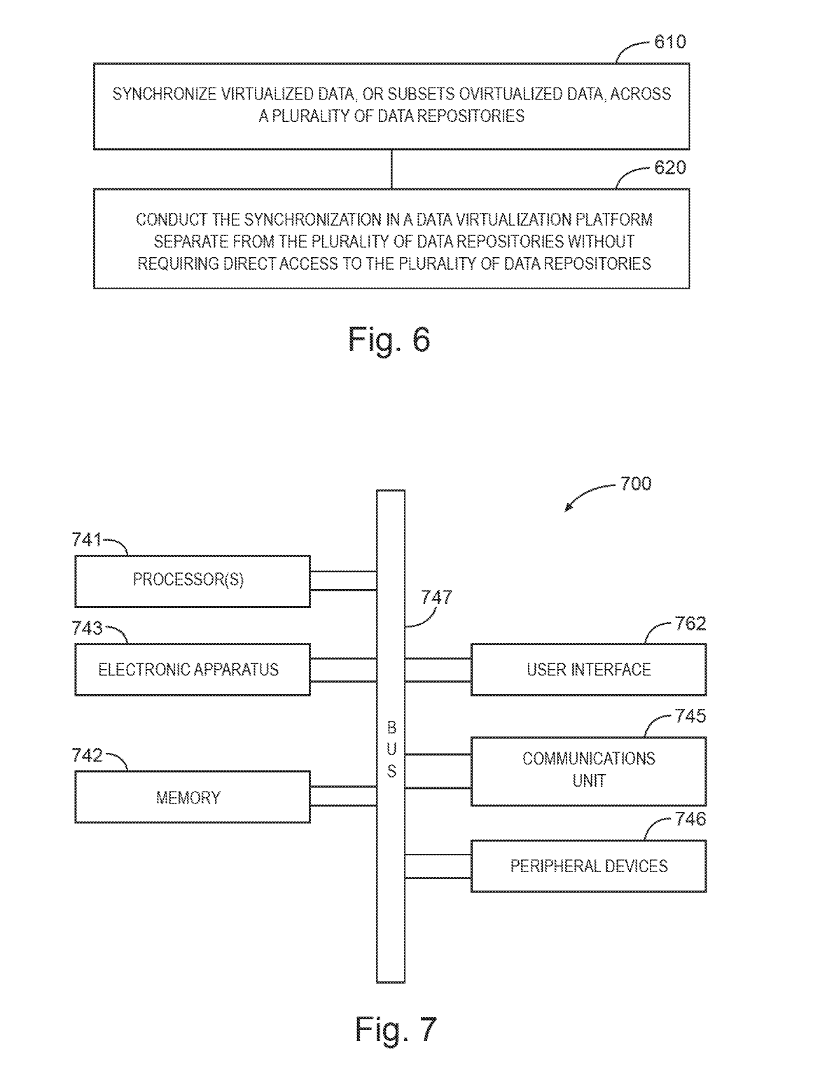

FIG. 6 is a flow diagram of an embodiment of an example method of synchronizing data. At 610, synchronizing virtualized data, or subsets of virtualized data, is synchronized across a plurality of data repositories. At 620, the synchronization is conducted in a data virtualization platform separate from the plurality of data repositories without requiring direct access to the plurality of data repositories.

A method 2 can include reading configuration data into a data virtualization platform, the configuration data being data regarding source repositories, destination repositories, and data mappings, the data virtualization platform including one or more servers, the data virtualization platform operable to communicate with a user device such that the user device accesses data from storage repositories via the data virtualization platform without direct connectivity to the storage repositories; updating a subset of originating data destined for a destination repository, the subset of originating data being from a source; checking the source for new changes since the source was last checked; identifying pending changes for the destination repository since a last synchronization of the destination repository, the pending changes being generated in one or more entities; checking for conflicts for pending changes; applying a conflict resolution policy; ordering the one or more entities in a fixed execution order prior to synchronize data; and synchronizing the data.

A method 3 can include the features of method 2 and can include applying pending insertions first; applying updates after applying pending insertions; and applying identified deletions after applying updates following applying the pending insertions first.

A method 4 can include the features of any of methods 2-3 and can include tracking and logging errors encountered during operations from reading the configuration data into a data virtualization platform to synchronizing the data; recording a transaction summary of a complete synchronization process conducting in synchronizing the data.

A method 5 can include the features of any of methods 2-4 and can include periodically invoking the reading, the updating, the checking for new changes, the identifying, the checking for conflicts; the applying, the ordering, and the synchronizing to enable a plurality of data repositories to incrementally achieve identical data content, across a connected network of repositories.

A method 6 can include the features of any of methods 2-5 and can include specifying the data mapping between source and destination repositories, the data mapping including: a configuration schema definition that constrains the validity of the configuration data; connection data for virtualized sources and destinations; parameters including synchronization interval; and attributes of the source and destination repositories.

A method 7 can include the features of any of methods 2-6 and can include using a data model and schema to store data and meta-data, the data model having entities and relationships that track one or more of the following: the meta-data, including an incrementing change tracking counter, associated with the changed attributes of all entities of all repositories, the meta-data associated with a subset of data from one originating repository to a destination repository; the meta-data associated with data gathered during prior synchronization cycles between the source and destination repositories; error associated with propagating the actual change associated with any given change meta-data; or stored synchronization transaction data including: the date and time of the conclusion of the synchronization activity; the unique source identifier, the unique destination identifier, the source entities, the destination entities, the source attributes, the destination attributes, the count of synchronized entities, the count of synchronized attributes, the count of entities with errors during synchronization, the count of attributes with errors during synchronization, and the starting and ending values of the meta-data counter.

A method 8 can include the features of any of methods 2-7 and can include checking for conflicts for pending changes including: checking for a three way match to detect attribute change conflicts by comparing a hash, or unique numeric code, of the source content, the hash, or unique numeric code, of the destination content, and the stored hash, or unique numeric code, of the last known synchronized content; taking into account the hierarchical relationships between entities; and skipping the pending change if it is detected that the destination already has the same content as the source change.

A method 9 can include the features of any of methods 2-8 and can include applying the conflict resolution policy resolves detected conflicts, applying the conflict resolution policy includes determining a winner in the event of a conflict and cancelling or applying the pending change as inferred from the determined policy.

A method 10 can include the features of any of methods 2-9 and can include, in conjunction with stored change meta-data, one or more of the following: tracking change meta-data at the entity and attribute level, allowing partial entity synchronization in the event that a destination is only interested in a subset of the attributes and entities; using a meta-data change counter to enable incremental synchronization of only the latest changes from a source repository to multiple concurrent destinations; propagating deleted information even when the source repositories do not retain, or provide, data regarding deleted information; or preventing redundant and spurious cycles of change related updates to the repositories that synchronize symmetrically.

Features of any of the various methods, as taught herein, or other combinations of features may be combined into a procedure according to the teachings herein.

In various embodiments, a non-transitory machine-readable storage device can comprise instructions stored thereon, which, when performed by a machine, cause the machine to perform operations, the operations comprising one or more features similar to or identical to features of methods and techniques described herein. The physical structures of such instructions may be operated on by one or more processors. Executing these physical structures can cause the machine to perform operations to: synchronize virtualized data, or subsets of virtualized data, across a plurality of data repositories; and conduct the synchronization in a data virtualization platform separate from the plurality of data repositories without requiring direct access to the plurality of data repositories.

The instructions can include instructions to: read configuration data into the data virtualization platform, the configuration data being data regarding source repositories, destination repositories, and data mappings, the data virtualization platform including one or more servers, the data virtualization platform operable to communicate with a user device such that the user device accesses data from storage repositories via the data virtualization platform without direct connectivity to the storage repositories; update a subset of originating data destined for a destination repository, the subset of originating data being from a source; check the source for new changes since the source was last checked; identify pending changes for the destination repository since a last synchronization of the destination repository, the pending changes being generated in one or more entities; check for conflicts for pending changes; apply a conflict resolution policy; order the one or more entities in a fixed execution order prior to synchronize data; and synchronize the data. The instruction can include instructions to: apply pending insertions first; apply updates after application of the pending insertions; and apply identified deletions after application of updates following application of the pending insertions first. The instruction can include instructions to: track and log errors encountered during operations from reading the configuration data into the data virtualization platform to synchronize the data; and record a transaction summary of a complete synchronization process conducted in synchronization of the data.

Further, a machine-readable storage device, herein, is a physical device that stores data represented by physical structure within the device. Such a physical device is a non-transitory device. Examples of machine-readable storage devices can include, but are not limited to, read only memory (ROM), random access memory (RAM), a magnetic disk storage device, an optical storage device, a flash memory, and other electronic, magnetic, and/or optical memory devices.

A system 1 can comprise: a data virtualization platform including: one or more servers; a communication interface arranged to receive data from and transmit data to user instruments; a communication interface arranged to receive data from and transmit data to storage repositories, the data virtualization platform structured to conduct synchronization within the data virtualization platform separate from the plurality of data repositories without requiring direct access to the plurality of data repositories.

A system 2 can include the structure of system 1 and can include the data virtualization platform structured to: read configuration data into the data virtualization platform, the configuration data being data regarding source repositories, destination repositories, and data mappings; update a subset of originating data destined for a destination repository, the subset of originating data being from a source; check the source for new changes since the source was last checked; identify pending changes for the destination repository since a last synchronization of the destination repository, the pending changes being generated in one or more entities; check for conflicts for pending changes; apply a conflict resolution policy; order the one or more entities in a fixed execution order prior to synchronize data; and synchronize the data.

A system 3 can include the structure of any of systems 1-2 and can include the data virtualization platform structured to: apply pending insertions first; apply updates after application of the pending insertions; and apply identified deletions after application of the updates following application of the pending insertions first.

A system 4 can include the structure of any of systems 1-3 and can include the data virtualization platform structured to: track and log errors encountered during operations from reading the configuration data into the data virtualization platform to synchronize the data; and record a transaction summary of a complete synchronization process conducted in synchronization of the data.

A system 5 can include the structure of any of systems 1-4 and can include the one or more servers including: a destination data server having a destination data view model; a source data server having a source data view model; and a synchronization data server having a synchronization data view model.

A system 6 can include the structure of any of systems 1-5 and can include the data virtualization platform including one or more of the following: a change interface having a change counter and arranged to hold a unique repository identifier, a change operation, an entity name, an attribute name, a hash of the changed attribute value, and a change status; a change collection interface structured to add a change, iterate through collected changes, retrieve a specific change, check if the collected changes contains a specific change, manage a list of entity keys for the change collection interface, and check if a given change is in conflict with the collected changes; a synchronizer interface structured to retrieve new source changes, set subsets of data from a source to a destination, synchronize two repositories to each other, reset change tracking meta-data, provide errors encountered, and log and report on transactions; a change source interface structured to fetch latest changes, attributes of each entity exposed by a source for synchronization, a list of attribute data types for the entity attributes, types of key attributes for every entity, and key attributes for every entity, and structured to delete an entity, insert an entity, update an entity, and specify a mapping to a configured destination entity; a sync specification interface having a source repository, a destination repository, a sync repository to store synchronization meta-data, and a sync map between source entities and destination entities; a sync map interface having a list of source entities, an identification of a destination repository, a query for a source subset that when executed on a source entity specifies a data subset targeted for the destination repository, and a set of attribute mappings from the source entity to the destination entity; a sync transaction interface that provides the attributes to store synchronization transaction information including date and time of conclusion of the synchronization activity, a unique source identifier, a unique destination identifier, source entities, destination entities, source attributes, destination attributes, and the starting and ending values of a meta-data counter; a sync status interface that provides the status of an ongoing synchronization operation via states that cycle between labels of success, pending, error, manual, skipped, and in source; a change hash interface structured to provide a hash or unique numeric code or an attribute value using an algorithm employed to compute a hash value, and data structures to maintain groups of hashes including collections, maps, and trees; a sync operation interface to describe modes and manner of changes from among no change, insertion, update, and deletion; or a sync exception interface that provides a synchronization error message and context associated with the synchronization error message.

A system 7 can include the structure of any of systems 1-6 and can include the change operation of the change interface including an insert, an update, or a delete.

FIG. 7 is a block diagram of an embodiment of an example system 700 that can be implemented in the example system architecture 10 of FIG. 1. The system 700 may implemented as a general structure of one or more components in the system architecture 10. The system 700 can be arranged to perform various operation on data, in a manner similar or identical to any of the processing techniques discussed herein.

The system 700 can include a processor 741, a memory 742, an electronic apparatus 743, and a communications unit 745. The processor 741, the memory 742, and the communications unit 745 can be arranged to operate as a processing unit to control operation of the data virtualization platform 101 or components of the data virtualization platform 101. In various embodiments, the processor 741 can be realized as a processor or a group of processors that may operate independently depending on an assigned function. Memory 742 may be realized as one or more databases.

The communications unit 745 can include communications between user instruments and a data virtualization platform and/or between the data virtualization platform and physical data storage repositories. Communications unit 745 may use combinations of wired communication technologies and wireless technologies.

The system 700 can also include a bus 747, where the bus 747 provides electrical conductivity among the components of the system 700. The bus 747 can include an address bus, a data bus, and a control bus, each independently configured. The bus 747 can be realized using a number of different communication mediums that allows for the distribution of components of the system 700. The bus 747 can include instrumentality for network communication. The use of bus 747 can be regulated by the processor 741.

In various embodiments, peripheral devices 746 can include displays, additional storage memory, or other control devices that may operate in conjunction with the processor 741 or the memory 742. The peripheral devices 746 can be arranged with a display, as a distributed component, that can be used with instructions stored in the memory 742 to implement a user interface 762 to manage the operation of the system 700 according to its implementation in the system architecture for data virtualization. Such a user interface 762 can be operated in conjunction with the communications unit 745 and the bus 747.

Structures and techniques, as taught herein, can serve as a basis for products directed to address a wide variety of data management tasks, particularly those that are complex. Use of a data virtualization platform provides a mechanism to address such complexity. The data virtualization platform may provide new workflows and techniques to collaborate with, opaque and hard to integrate, tools and user instruments without making significant custom data repository modifications and middle-ware additions. The data virtualization platform can provide effective data integration and coherence across applications and systems, which may provide enhanced enablement and management of data management tasks

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

What is claimed is:

1. A method comprising:
synchronizing virtualized data, or subsets of virtualized data, across a plurality of data repositories; and
conducting the synchronization in a data virtualization platform separate from the plurality of data repositories without requiring direct access to the plurality of data repositories.

2. A method comprising;
reading configuration data into a data virtualization platform, the configuration data being data regarding source repositories, destination repositories, and data mappings, the data virtualization platform including one or more servers, the data virtualization platform operable to communicate with a user device such that the user device accesses data from storage repositories via the data virtualization platform without direct connectivity to the storage repositories;
updating a subset of originating data destined for a destination repository, the subset of originating data being from a source;
checking the source for new changes since the source was last checked;
identifying pending changes for the destination repository since a last synchronization of the destination repository, the pending changes being generated in one or more entities;
checking for conflicts for pending changes;
applying a conflict resolution policy;
ordering the one or more entities in a fixed execution order prior to synchronize data; and
synchronizing the data.

3. The method of claim 2, wherein the method includes
applying pending insertions first;
applying updates after applying pending insertions; and
applying identified deletions after applying updates following applying the pending insertions first.

4. The method of claim 2, wherein the method includes:
tracking and logging errors encountered during operations from reading the configuration data into the data virtualization platform to synchronize the data; and
recording a transaction summary of a complete synchronization process conducting the synchronization of the data.

5. The method of claim 2, wherein the method includes periodically invoking the reading, the updating, the checking for new changes, the identifying, the checking for conflicts; the applying, the ordering, and the synchronizing to enable a plurality of data repositories to incrementally achieve identical data content, across a connected network of repositories.

6. The method of claim 2, wherein the method includes specifying the data mapping between source and destination repositories, the data mapping including:
a configuration schema definition that constrains the validity of the configuration data;
connection data for virtualized sources and destinations;
parameters including synchronization interval; and
attributes of the source and destination repositories.

7. The method of claim 2, wherein the method includes using a data model and schema to store data and meta-data, the data model having entities and relationships that track one or more of the following:
the meta-data, including an incrementing change tracking counter, associated with the changed attributes of all entities of all repositories, the meta-data associated with a subset of data from one originating repository to a destination repository;
the meta-data associated with data gathered during prior synchronization cycles between the source and destination repositories;
error associated with propagating the actual change associated with any given change meta-data; or
stored synchronization transaction data including: the date and time of the conclusion of the synchronization activity; the unique source identifier, the unique destination identifier, the source entities, the destination entities, the source attributes, the destination attributes, the count of synchronized entities, the count of synchronized attributes, the count of entities with errors during synchronization, the count of attributes with errors during synchronization, and the starting and ending values of the meta-data counter.

8. The method of claim 2, wherein checking for conflicts for pending changes includes:
checking for a three way match to detect attribute change conflicts by comparing a hash, or unique numeric code, of the source content, the hash, or unique numeric code, of the destination content, and the stored hash, or unique numeric code, of the last known synchronized content;
taking into account the hierarchical relationships between entities; and
skipping the pending change if it is detected that the destination already has the same content as the source change.

9. The method of claim 2, wherein applying the conflict resolution policy resolves detected conflicts, applying the conflict resolution policy includes determining a winner in the event of a conflict and cancelling or applying the pending change as inferred from the determined policy.

10. The method claim 2, wherein in conjunction with stored change meta-data, the method includes one or more of the following:
tracking change meta-data at the entity and attribute level, allowing partial entity synchronization in the event that a destination is only interested in a subset of the attributes and entities;
using a meta-data change counter to enable incremental synchronization of only the latest changes from a source repository to multiple concurrent destinations;
propagating deleted information even when the source repositories do not retain, or provide, data regarding deleted information; or
preventing redundant and spurious cycles of change related updates to the repositories that synchronize symmetrically.

11. A system comprising:
a data virtualization platform including:
one or more servers;
a communication interface arranged to receive data from and transmit data to user instruments;
a communication interface arranged to receive data from and transmit data to storage repositories, the data virtualization platform structured to conduct synchronization within the data virtualization platform separate from the plurality of data repositories without requiring direct access to the plurality of data repositories.

12. The system of claim 11, wherein the data virtualization platform is structured to:
read configuration data into the data virtualization platform, the configuration data being data regarding source repositories, destination repositories, and data mappings;
update a subset of originating data destined for a destination repository, the subset of originating data being from a source;
check the source for new changes since the source was last checked;
identify pending changes for the destination repository since a last synchronization of the destination repository, the pending changes being generated in one or more entities;
check for conflicts for pending changes;
apply a conflict resolution policy;
order the one or more entities in a fixed execution order prior to synchronize data; and
synchronize the data.

13. The system of claim 12, wherein the data virtualization platform is structured to:
apply pending insertions first;
apply updates after application of the pending insertions; and
apply identified deletions after application of the updates following application of the pending insertions first.

14. The system of claim 12, wherein the data virtualization platform is structured to:
track and log errors encountered during operations from reading the configuration data into the data virtualization platform to synchronize the data; and
record a transaction summary of a complete synchronization process conducted in synchronization of the data.

15. The system of claim 12, wherein one or more servers includes:
a destination data server having a destination data view model;
a source data server having a source data view model; and
a synchronization data server having a synchronization data view model.

16. The system of claim 12, wherein the data virtualization platform includes one or more of the following:
a change interface having a change counter and arranged to hold a unique repository identifier, a change operation, an entity name, an attribute name, a hash of the changed attribute value, and a change status;
a change collection interface structured to add a change, iterate through collected changes, retrieve a specific change, check if the collected changes contains a specific change, manage a list of entity keys for the change collection interface, and check if a given change is in conflict with the collected changes;
a synchronizer interface structured to retrieve new source changes, set subsets of data from a source to a destination, synchronize two repositories to each other, reset change tracking meta-data, provide errors encountered, and log and report on transactions;
a change source interface structured to fetch latest changes, attributes of each entity exposed by a source for synchronization, a list of attribute data types for the entity attributes, types of key attributes for every entity, and key attributes for every entity, and structured to delete an entity, insert an entity, update an entity, and specify a mapping to a configured destination entity;
a sync specification interface having a source repository, a destination repository, a sync repository to store synchronization meta-data, and a sync map between source entities and destination entities;
a sync map interface having a list of source entities, an identification of a destination repository, a query for a source subset that when executed on a source entity specifies a data subset targeted for the destination repository, and a set of attribute mappings from the source entity to the destination entity;
a sync transaction interface that provides the attributes to store synchronization transaction information including date and time of conclusion of the synchronization activity, a unique source identifier, a unique destination identifier, source entities, destination entities, source attributes, destination attributes, and the starting and ending values of a meta-data counter;
a sync status interface that provides the status of an ongoing synchronization operation via states that cycle between labels of success, pending, error, manual, skipped, and in source;
a change hash interface structured to provide a hash or unique numeric code or an attribute value using an algorithm employed to compute a hash value, and data structures to maintain groups of hashes including collections, maps, and trees;
a sync operation interface to describe modes and manner of changes from among no change, insertion, update, and deletion; or
a sync exception interface that provides a synchronization error message and context associated with the synchronization error message.

17. The system of claim 16, wherein the change operation of the change interface includes an insert, an update, or a delete.

18. A non-transitory machine-readable storage device having instructions stored thereon, which, when performed by a machine, cause the machine to perform operations to:
synchronize virtualized data, or subsets of virtualized data, across a plurality of data repositories; and
conduct the synchronization in a data virtualization platform separate from the plurality of data repositories without requiring direct access to the plurality of data repositories.

19. The non-transitory machine-readable storage device of claim 18, wherein the instructions include instructions to:
read configuration data into the data virtualization platform, the configuration data being data regarding source repositories, destination repositories, and data mappings, the data virtualization platform including one or more servers, the data virtualization platform operable to communicate with a user device such that the user device accesses data from storage repositories via the data virtualization platform without direct connectivity to the storage repositories;
update a subset of originating data destined for a destination repository, the subset of originating data being from a source;
check the source for new changes since the source was last checked;
identify pending changes for the destination repository since a last synchronization of the destination repository, the pending changes being generated in one or more entities;
check for conflicts for pending changes;
apply a conflict resolution policy;
order the one or more entities in a fixed execution order prior to synchronize data; and
synchronize the data.

20. The non-transitory machine-readable storage device of claim 19, wherein the instructions include instructions to:
apply pending insertions first;
apply updates after application of the pending insertions; and
apply identified deletions after application of updates following application of the pending insertions first.

21. The non-transitory machine-readable storage device of claim 19, wherein the instructions include instructions to:
track and log errors encountered during operations from reading the configuration data into the data virtualization platform to synchronize the data; and
record a transaction summary of a complete synchronization process conducted in synchronization of the data.
